(19) United States
(12) Patent Application Publication
(10) Pub. No.: US 2025/0327198 A1
(43) Pub. Date: Oct. 23, 2025

(54) Water electrolysis catalyst and water electrolysis device

(71) Applicant: Shanghai Juna New Material Technology Co., Ltd., Shanghai (CN)

(72) Inventors: Jiajia ZHANG, Shanghai (CN); Zhengyang CAI, Shanghai (CN); Shuai XU, Shanghai (CN); Xiaomeng WANG, Shanghai (CN); Min HUANG, Shanghai (CN); Xianying WANG, Shanghai (CN); Zhensheng ZHOU, Shanghai (CN)

(73) Assignee: Shanghai Juna New Material Technology Co., Ltd., Shanghai (CN)

(21) Appl. No.: 19/253,984

(22) Filed: Jun. 30, 2025

Related U.S. Application Data
(63) Continuation of application No. PCT/CN2023/143270, filed on Dec. 29, 2023.

(30) Foreign Application Priority Data
Dec. 31, 2022 (CN) 202211735921.3
Dec. 28, 2023 (CN) 202323634160.5

(51) Int. Cl. C25B 11/037; C25B 9/23; C25B 11/032; C25B 11/052; C25B 11/089

(52) U.S. Cl. CPC C25B 11/037; C25B 9/23; C25B 11/032; C25B 11/052; C25B 11/089

(57) ABSTRACT

The disclosure provides a water electrolysis catalyst and a water electrolysis device. The water electrolysis catalyst includes a catalyst support layer and a catalyst. The catalyst grows vertically and orderly on the catalyst support layer, and the catalyst has a nanowire or nanochain microstructure. The water electrolysis catalyst further includes nanoparticles stacked to form the nanowire or nanochain microstructures, and a diameter of the nanoparticles is from 5 nm to 500 nm.

### CROSS REFERENCE TO RELATED APPLICATION

The present application is a continuation application of PCT application No. PCT/CN2023/143270 filed on Dec. 29, 2023, which claims the benefit of CN202211735921.3 filed on Dec. 31, 2022, and CN202323634160.5 filed on Dec. 28, 2023. All the above are hereby incorporated by reference for all purposes.

### TECHNICAL FIELD

The disclosure relates to a technical field of hydrogen production by water electrolysis, and in particular to a water electrolysis catalyst and a water electrolysis device.

### BACKGROUND

Hydrogen is considered to be the most promising energy support. Its combustion product is only water, and its energy density may be more than three times that of gasoline. Through electrochemical water splitting, a stable and green conversion from electrical energy to chemical energy may be achieved.

However, the low hydrogen energy conversion efficiency seriously restricts the industrialization process of hydrogen production by water electrolysis. In addition, traditionally prepared catalyst layers have poor stability in industrial electrolyzers.

### SUMMARY

The disclosure provides a water electrolysis catalyst and a water electrolysis device, and the water electrolysis catalyst and the water electrolysis can improve catalytic activity, reduce energy consumption, and improve catalyst stability.

One or more embodiments of the disclosure provide the water electrolysis catalyst, and the water electrolysis catalyst includes nanowire or nanochain microstructures, and nanoparticles.

The nanowire or nanochain microstructures are formed on a catalyst support layer.

The nanoparticles are stacked to form the nanowire or nanochain microstructures.

In summary, the disclosure provides the water electrolysis catalyst and the water electrolysis device, and the water electrolysis catalyst can improve a bonding with the catalyst support layer, and improve the catalytic activity and catalytic efficiency. The disclosure can quickly diffuse and transmit gas generated by electrolysis to improve efficiency of water electrolysis.

### BRIEF DESCRIPTION OF THE DRAWINGS

In order to explain technical solutions of embodiments of the disclosure more clearly, the following will briefly introduce drawings used in a description of the embodiments or the conventional art. Obviously, the drawings in the following description are only some embodiments of the disclosure. For those of ordinary skill in the art, other drawings may be obtained based on these drawings without creative work.

FIG. 1 is a schematic view of a distribution of a water electrolysis catalyst according to an embodiment of the disclosure.

FIG. 2 is an appearance view of the water electrolysis catalyst according to an embodiment of the disclosure.

FIG. 3 is another appearance view of the water electrolysis catalyst according to an embodiment of the disclosure.

FIG. 4 is an SEM view of the water electrolysis catalyst according to an embodiment of the disclosure.

FIG. 5 is another SEM view of the water electrolysis catalyst according to an embodiment of the disclosure.

FIG. 6 is a schematic view of a distribution of a first portion and a second portion of the water electrolysis catalyst according to an embodiment of the disclosure.

FIG. 7 is a performance comparison view of the water electrolysis catalyst obtained in an embodiment of the disclosure with a traditional alkaline electrode sheet.

FIG. 8 is a comparison view of electrochemical test results of the water electrolysis catalyst obtained in an embodiment of the disclosure with the traditional alkaline electrode sheet.

FIG. 9 is a first schematic view of a water electrolysis device according to an embodiment.

FIG. 10 is a second schematic view of the water electrolysis device according to an embodiment.

### DETAILED DESCRIPTION

The following describes the implementation of the disclosure through specific embodiments, and those skilled in the art can easily understand other advantages and effects of the disclosure from the content disclosed in this specification. The disclosure may also be implemented or applied through other different specific embodiments. Various details in this specification may also be modified or changed based on different viewpoints and applications without departing from the disclosure.

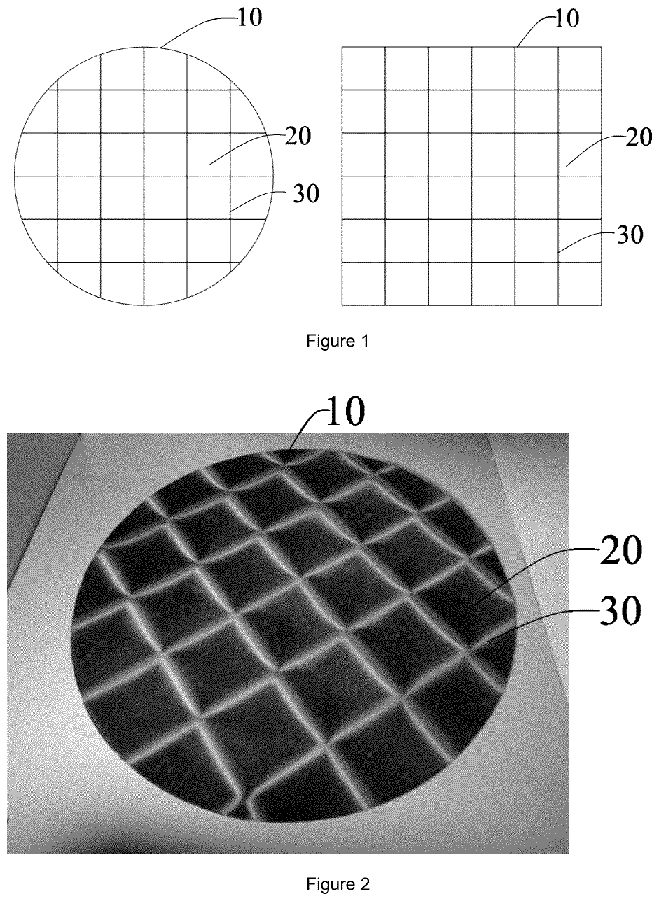

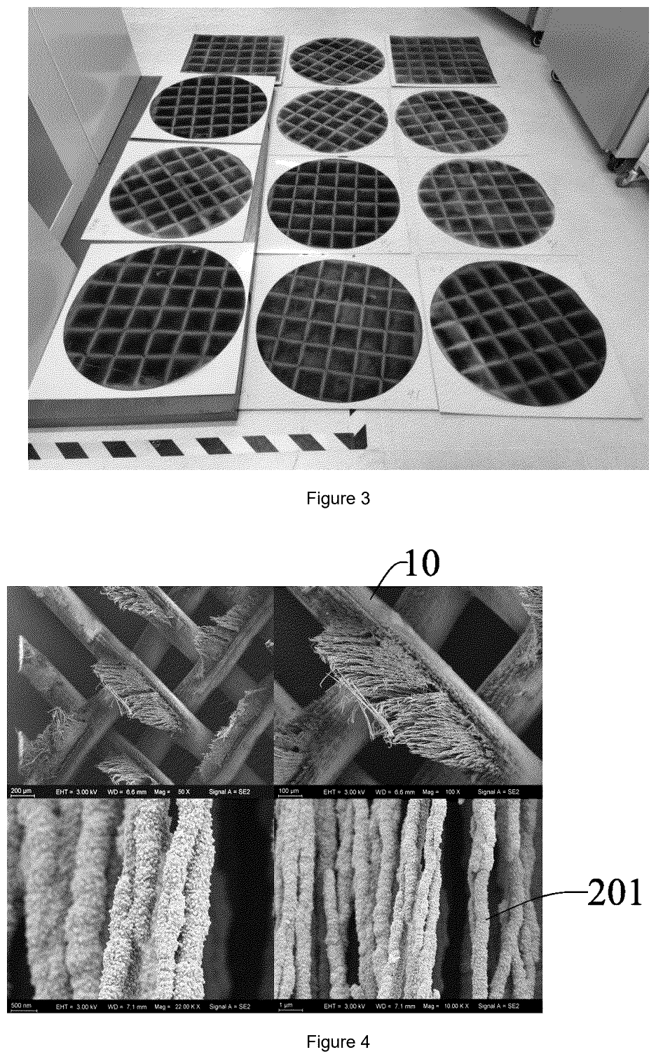

Please refer to FIG. 1 through FIG. 3. The disclosure provides a water electrolysis catalyst, and the water electrolysis catalyst includes a catalyst support layer 10, a catalyst layer 20 and at least one gas passage channel 30 and so on. The catalyst layer 20 can be, for example, vertically and orderly formed on the catalyst support layer 10, and the at least one gas passage channel 30 may be formed on the catalyst support layer 10. The at least one gas passage channel 30 can divide the catalyst layer 20 on the catalyst support layer 10 into a plurality of regions. The catalyst support layer 10 can be used to carry the catalyst layer 20, and the catalyst layer 20 can be used to catalyze a water electrolysis. The at least one gas passage channel 30 may be formed, for example, on the catalyst support layer 10 without the catalyst layer, and is configured to expose at least one part of a surface of the catalyst support layer 10, the at least one gas passage channel can be used to quickly diffuse and transmit gas generated by electrolysis to improve the water electrolysis efficiency.

Please refer to FIG. 1 through FIG. 3. In an embodiment of the disclosure, a surface shape of the catalyst support layer 10 may be, for example, square, circular, or any other shape. The catalyst support layer 10 may be, for example, any porous layer or diffusion layer of nickel foam, nickel mesh or carbon cloth, for diffusing gas. In an embodiment of the disclosure, an area of the catalyst support layer 10 may be, for example, greater than or equal to 0.5 m². In another embodiment of the disclosure, the area of the catalyst support layer 10 may be, for example, greater than or equal to 1.0 m². In another embodiment of the present application, the area of the catalyst support layer 10 may be, for example, from 0.1 m² to 5.0 m². In an embodiment of the disclosure, the catalyst support layer 10 may be, for example, in any other suitable shape.

However, it is not limited thereto, and the catalyst support layer 10 may also be a membrane layer in an electrolyzer, such as a diaphragm, a proton exchange membrane, or an anion exchange membrane. At this time, the catalyst support layer 10 with the catalyst layer 20 may be used as a membrane electrode of the electrolyzer.

In an embodiment, both the catalyst layer 20 and the at least one gas passage channel 30 may be formed only at one side of the catalyst support layer 10, such as a side close to or far away from a center (a membrane layer position) of the electrolyzer. However, the disclosure is not limited thereto. In another embodiment, both the catalyst layer 20 and the at least one gas passage channel 30 may also be formed at two opposite sides of the catalyst support layer 10.

It is worth noting that the catalyst layer 20 of the disclosure may be formed at a single side or at two opposite sides of the catalyst support layer 10 (porous material, diffusion layer, membrane layer, diaphragm, proton exchange membrane, anion exchange membrane or any other support layer).

Please refer to FIG. 1 through FIG. 3. In an embodiment of the disclosure, a plurality of the gas passage channels 30 can be distributed on the catalyst support layer 10 for example in a rectangular, square, curved shape or intersected at a fixed point. In an exemplary embodiment, the fixed point may be a center of the catalyst support layer. In an embodiment of the disclosure, the plurality of the gas passage channels 30 may be distributed on the catalyst support layer 10 in a rectangular shape, that is, the plurality of the gas passage channels 30 may be distributed in a grid manner on the catalyst support layer 10, in order to divide the catalyst layer 20 loaded on the catalyst support layer 10 into a plurality of grid-shaped areas. A length or width of a grid of the grid-shaped catalyst layer loaded on the catalyst support layer 10 is, for example, from 1 cm to 100 cm, or 5 cm to 30 cm. In an embodiment of the disclosure, a width of the gas passage channel 30 is for example from 0.1 cm to 5 cm.

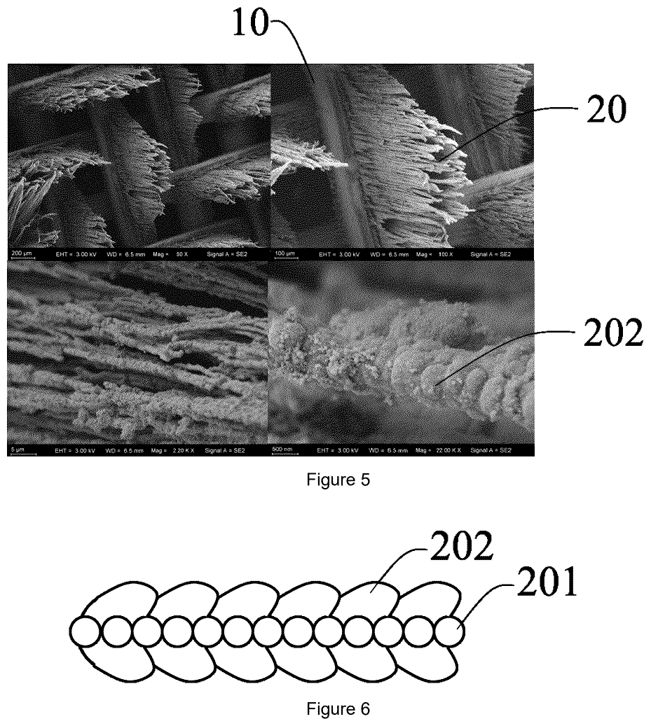

Please refer to FIG. 4 through FIG. 5. In an embodiment of the disclosure, the catalyst layer 20 may be, for example, a nickel alloy, a nickel-iron-based multi-component alloy or other alloys, and microscopic features of the catalyst layer 20 can include ordered nanowires or nanochain microstructures. A diameter of the nanowire or nanochain is, for example, from 0.1 μm to 2.0 μm and a length of the nanowire or nanochain is from 0.1 μm to 200 μm. In an embodiment of the disclosure, the catalyst layer 20 can include, for example, following components in mass percentage: 70% to 95% Ni, 4.98% to 14.98% Fe, and remainder being a noble metal or a transition metal, wherein the noble metal or the transition metal can be at least one of platinum, ruthenium, and molybdenum. In an embodiment of the disclosure, the catalyst layer 20 can include, for example, following components in mass percentage: 85% to 95% Ni, 0.02% to 10.2% at least one of platinum, ruthenium and molybdenum, and 4.98% to 14.98% Fe.

Please refer to FIG. 4 through FIG. 5. In an embodiment of the disclosure, the micromorphology feature structures of the catalyst layer 20 may be the nanowires or nanochains. A wire diameter of the nanowire may be, for example, from 0.1 μm to 1.2 μm and a length of the nanowire may be from 0.1 μm to 100 μm. The nanowire includes at least one first portion 201 and at least one second portion 202. The second portion 202 can be coated on the first portion 201. The second portion 202 can, for example, include a nanosheet layer structure coated on the first portion 201. In an embodiment of the disclosure, the first portion 201 may be a skeleton portion, and the skeleton portion can include nickel-platinum nanowires including “stacked” nanoparticles and with a length from 0.1 μm to 0.6 μm. The second portion 202 can include, for example, honeycomb nanowires assembled by nickel-iron nanosheets based on the skeleton portion, and the second portion 202 can have a length from 0.1 μm to 100 μm. In an embodiment of the disclosure, a diameter of the nanoparticle may be for example from 5 nm to 500 nm.

It is worth noting that the nanowires or nanochains of the catalyst layer 20 may be formed in-situ on the support layer. When the nanowires or nanochains are formed by an in-situ growth method, metal ions in original solution may be directly reduced on the support layer (the porous layer or the membrane layer) to form nanoparticles, and the reduced nanoparticles may be directly arranged in an orderly manner into the nanowires or the nanochains on the support layer, thereby directly forming the nanowires or the nanochains on the support layer. Furthermore, by forming the nanowires or the nanochains through the in-situ growth method, the nanowires and the support layer (the porous layer or the membrane layer) may have better binding strength, so that the catalyst layer 20 can be more stably formed on the support layer (the porous layer or the membrane layer), and the vertical nanowires or nanochains can be formed in an orderly manner by the nanoparticles with a specific size of the disclosure, thereby improving the electrolysis efficiency of the catalyst layer.

Please refer to FIG. 5 through FIG. 6. In an embodiment of the disclosure, a main component of the second portion 202 may be, for example, a nickel-iron nanosheet structure. The second portion 202 of the catalyst layer 20 may be, for example, coated on the first portion 201 in a fish scale shape. That is, a thickness of the second portion 202 may be not of uniform thickness on the first portion 201, and there may be a partial overlap between the nanosheet structures. In this disclosure, the catalyst layer may adopt the nanoparticles to form nanowires, and then adopt the nanowires to form the nanosheet layers through the assembly of the nanowires, therefore a bonding strength of the catalyst layer and the catalyst support layer may be improved, a contact area of the catalyst layer and water during the water electrolysis may be increased at the same time, so that the catalytic activity and catalytic efficiency can be improved.

It is worth noting that the second portion 202 at least partially covering the first portion 201 may also be in other shapes, such as granular or irregular shapes.

In some embodiments, the catalyst layer 20 may be an anode catalyst layer. At this time, the catalyst layer 20 may include the first portion 201 and the second portion 202. The first portion 201 may be the nanowire or the nanochain composed of the nanoparticles, and the second portion 202 may be the nanosheet structure and coated on the nanowire or the nanochain of the first portion 201. Main components of the first portion 201 and the second portion 202 may be different. For example, the main component of the first portion 201 may be nickel (for example, a composition in mass percentage: 85% to 99.8% Ni, and remainder may be noble metals or transition metals), and the main components of the second portion 202 may be nickel and iron (for example, a composition in mass percentage: 85% to 95% Ni, 4.98% to 14.98% Fe, and remainder may be noble metals or transition metals). When the catalyst layer 20 is disposed in the electrolyzer, the catalyst layer 20 as an anode catalyst layer may include the first portion 201 and the second portion 202, and the main components of the first portion 201 and the second portion 202 may be different. At this time, the catalyst layer 20 as a cathode catalyst layer may include only the nanowires or the nanochains of the first portion 201.

However, it is not limited thereto. In some embodiments, the catalyst layer 20 serving as an anode catalyst layer and the cathode catalyst layer may also only include the nanowires or the nanochains of the first portion 201 without being covered by the second portion 202. At this time, main components of the catalyst layer 20 used as the anode catalyst layer and the cathode catalyst layer may be the same (for example, components in terms of mass percentage: 70% to 95% Ni, 4.98% to 29.98% Fe, and remainder may be noble metals or transition metals) or different.

Please refer to FIG. 4 through FIG. 5. In order to observe the water electrolysis catalyst of a specific embodiment of the disclosure through a scanning electron microscope (SEM), scanning electron microscope images shown in FIG. 4 and FIG. 5 are obtained. As can be seen from FIG. 4, a micromorphology of the catalyst layer in the embodiment of the disclosure may have nanowire or nanochain structures, the nanowires or the nanochains may be formed substantially vertically on a base material (catalyst support layer). The nanowire or nanochain structure is “stacked” by the nanoparticles. The wire diameter of the nanowire may be, for example, from 0.1 μm to 0.6 μm, and the length of the nanowire may be from 0.1 μm to 100 μm. As can be seen from FIG. 5, in one embodiment of the disclosure, the micromorphology of the catalyst layer 20 may be, for example, platinum nickel iron nanowires grow vertically on the catalyst support layer, and a wire diameter of the platinum nickel iron nanowires may be from 0.1 μm to 1.2 μm, and the platinum nickel iron nanowires can include the first portion and the second portion. The first portion may be the skeleton portion, the skeleton portion can include the nanowires or the nanochains of 0.1 μm to 0.6 μm “stacked” by nanoparticles, and the second portion is the nanowire assembled from nanosheets based on the skeleton portion, such as a honeycomb or fish scale-shaped nanowire, and the length of the nanowire is, for example: from 0.1 μm to 100 μm.

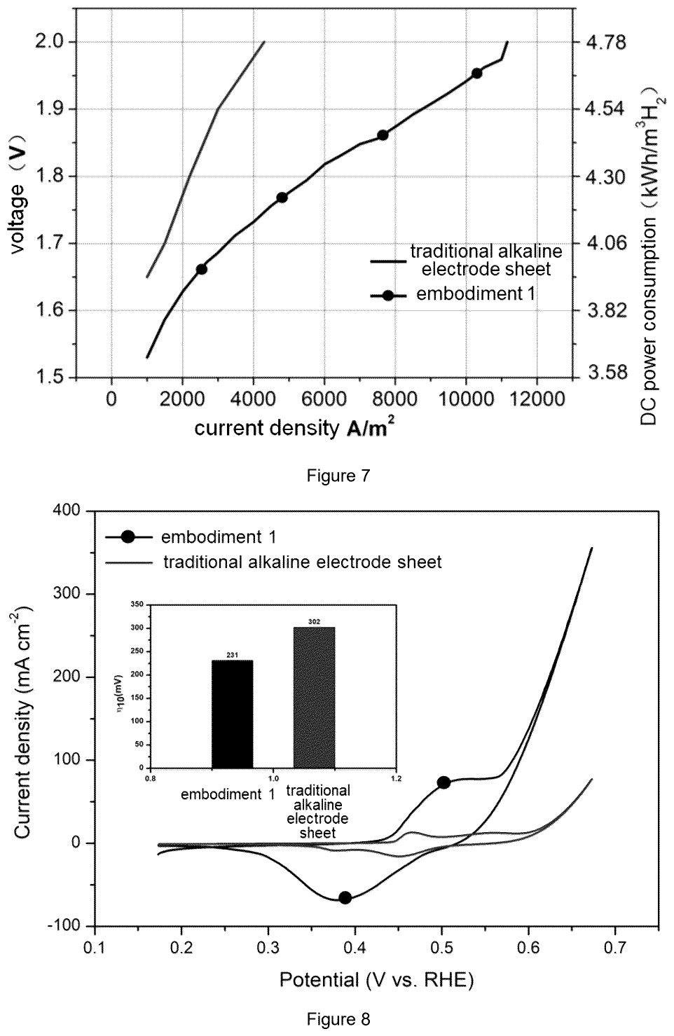

Please refer to FIG. 7. The water electrolysis catalyst in one embodiment of the disclosure can be assembled into an alkaline solution electrolyzer (embodiment 1) with a diaphragm and electrode plates, and a working condition test is performed. A performance of the water electrolysis catalyst prepared in this embodiment is compared with a performance of a traditional alkaline electrode sheet, and the traditional alkaline electrode sheets are, for example, a “nickel mesh with Raney nickel plating layer” structure. Please refer to FIG. 7. For example, an electrochemical test method is used to compare the performance of the water electrolysis catalyst prepared in this embodiment with the performance of the traditional alkaline electrode sheet. A current density of the water electrolysis catalyst in this embodiment may reach up to 11000 A/m² at 2.0V, and this is better than the traditional alkaline electrode sheet.

Please refer to FIG. 8. An electrochemical activity of the water electrolysis catalyst prepared in this embodiment is compared with an electrochemical activity of the traditional alkaline electrode sheet, and the traditional alkaline electrode sheet is, for example, the “nickel mesh with Raney nickel plating layer” structure. The electrochemical activity of the water electrolysis catalyst prepared in this embodiment is better than the electrochemical activity of the traditional alkaline electrode sheet, and an overpotential of oxygen evolution η10 is 231 mV for the water electrolysis catalyst prepared in this embodiment, and 302 mV for Raney nickel.

It is worth noting that the water electrolysis catalyst of FIG. 7 and FIG. 8 is used in the alkaline solution electrolyzer, but is not limited to this. The water electrolysis catalyst of the disclosure may also be used in electrolyzers using other catalyst electrodes, such as proton exchange membrane (PEM) electrolyzers, anion exchange membrane (AEM), solid oxide electrolyzer cell (SOEC) or other electrolyzers using the catalyst electrodes. At this time, a water electrolysis device (such as a hydrogen production electrolyzer) or system using the catalyst layer of the disclosure may include the membrane layer 101, the diffusion layer 102, and the catalyst layer 20, wherein the catalyst layer 20 can be located between the membrane layer 101 and the diffusion layer 102.

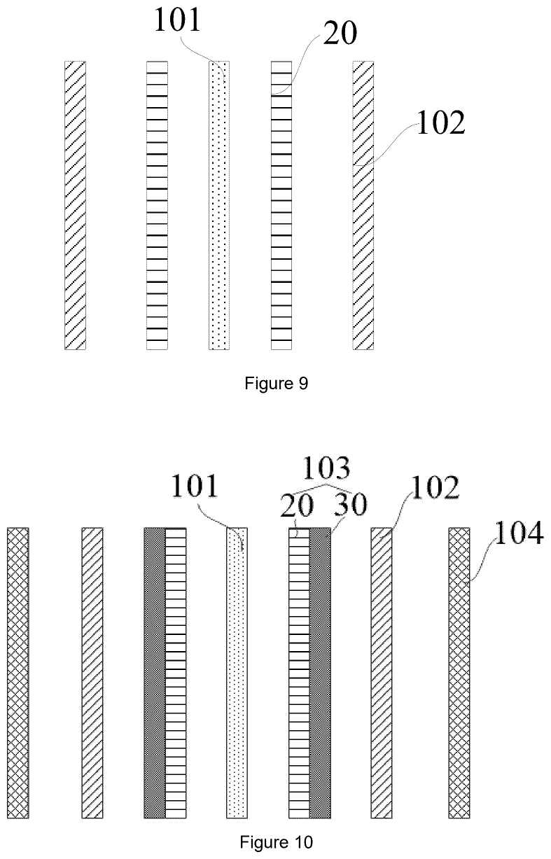

In some embodiments, please refer to FIG. 9. The catalyst layer of the disclosure may be applied to the hydrogen production electrolyzer, and the hydrogen production electrolyzer can include the membrane layer 101, at least two diffusion layers 102, and at least one catalyst layer. The diffusion layers 102 can be located at two sides of the membrane layer 101. The catalyst layer 20 may be formed between the membrane layer 101 and the diffusion layer 102. In an embodiment, the catalyst layer 20 may be formed on a single side surface of the diffusion layer 102 and close to the membrane layer 101. In another embodiment, the catalyst layer 20 may also be formed on two side surfaces of the diffusion layer 102. In another embodiment, the catalyst layer 20 may be formed on two side surfaces of the membrane layer 101. It is worth noting that the membrane layer 101 may be the diaphragm, the proton exchange membrane (PEM), the anion exchange membrane or other membrane layer used for hydrogen electrolysis, and the diffusion layer 102 may be the nickel mesh, the nickel foam, the carbon mesh or other porous layer.

In some embodiments, please refer to FIG. 9. The hydrogen production electrolyzer (or water electrolysis device) of the disclosure may include a plurality of electrolysis units (or electrolysis chambers), and each electrolysis unit may include the membrane layer 101, at least two diffusion layers 102 and at least one catalyst layer 20.

In some embodiments, please refer to FIG. 10. The catalyst layer of the disclosure may be applied to the hydrogen production electrolyzer, and the hydrogen production electrolyzer may include the membrane layer 101, at least two diffusion layers 102, at least two electrode sheets 103 and an electrode plate 104. The diffusion layers 102 can be located at the two sides of the membrane layer 101. The electrode sheets 103 can be respectively formed between the membrane layer 101 and the diffusion layers 102. The electrode sheets 103 may be an anode electrode sheet and a cathode electrode sheet respectively. The electrode sheet 103 may include the catalyst layer 20 and the catalyst support layer 30. The catalyst layer 20 may be formed on a single side surface of the catalyst support layer 30 and close to the membrane layer 101, or the catalyst layer 20 may be formed on two side surfaces of the catalyst support layer 30. It is worth noting that, in the embodiment of FIG. 10, the membrane layer 101 may be the diaphragm, the proton exchange membrane (PEM), the anion exchange membrane or other membrane layer used for hydrogen electrolysis, and the diffusion layer 102 and the catalyst support layer 30 may be the nickel mesh, the nickel foam, the carbon mesh or other porous layer.

In some embodiments, the electrode plate 104 may be made of, for example, a stainless steel plate plated with nickel, a nickel plate, or other metal/alloy plates.

In some embodiments, please refer to FIG. 10. The hydrogen production electrolyzer (or water electrolysis device) of the disclosure may include a plurality of electrolysis units (or electrolysis chambers), and each electrolysis unit may include the membrane layer 101, at least two diffusion layers 102, at least two electrode sheets 103 and the electrode plate 104.

In some embodiments, the membrane layer may be the diaphragm (for example a composite diaphragm), and a main component of the diaphragm may be, for example, polyphenylene sulfide, zirconium oxide and/or polysulfone.

In some embodiments, a pores per linear inch (PPI) of the diffusion layer may be, for example, less than 100, or, for example, less than 80. In some embodiments, a thickness of the diffusion layer may be for example from 1.5 mm to 10 mm. In some embodiments, a nickel content per square meter of the nickel foam or nickel mesh may be, for example, greater than 500 g/m².

In some different embodiments, a main component of the catalyst layer 20 attached to the cathode electrode may be, for example, Pt, Ni and/or other metals/alloys, and a main component of the catalyst layer attached to the anode electrode may be, for example, Pt, Ni, Fe and/or other metals/alloys.

It is worth noting that a composition of the catalyst layer 20 of the disclosure is not limited to the above-mentioned metals/alloys, and may also be any other suitable metals/alloys/materials, such as high entropy materials.

In summary, the disclosure provides the water electrolysis catalyst and the water electrolysis device. The catalyst layer may form the nanoparticles, for example, by in-situ growth method and orderly form the nanowires. By arranging the at least one gas passage channel, the gas generated by the electrolysis may be quickly diffused and transmitted during the electrolysis, so as to improve the efficiency of water electrolysis. The water electrolysis catalyst prepared in the disclosure can be used in the water electrolysis device, and may have higher catalytic activity, lower energy consumption, and better stability.

The above embodiments only illustrate principles and effects of the disclosure, but are not intended to limit the disclosure. Anyone familiar with this technology may modify or change the above embodiments without departing from a scope of the disclosure. Therefore, all equivalent modifications or changes made by those with ordinary knowledge in the technical field without departing from the technical ideas disclosed in the disclosure shall still be covered by the claims of the disclosure.

What is claimed is:

1. A water electrolysis catalyst, comprising:
nanowire or nanochain microstructures, formed on a catalyst support layer; and
nanoparticles, stacked to form the nanowire or nanochain microstructures, wherein, a diameter of the nanoparticles is from 5 nm to 500 nm.

2. The water electrolysis catalyst according to claim 1, wherein, the catalyst comprises a first portion and a second portion, the second portion is wrapped around the first portion.

3. The water electrolysis catalyst according to claim 2, wherein, a wire diameter of the first portion is from 0.1 μm to 1.2 μm and a length of the first portion is from 0.1 μm to 0.6 μm.

4. The water electrolysis catalyst according to claim 2, wherein, a length of the second portion is from 0.1 μm to 100 μm.

5. The water electrolysis catalyst according to claim 2, wherein, the second portion comprises nanosheet layer structures, and the first portion is covered by the nanosheet layer structures.

6. The water electrolysis catalyst according to claim 1, wherein, a diameter of the nanowire or nanochain is from 0.1 μm to 2.0 μm, and a length of the nanowire or nanochain is from 0.1 μm to 200 μm.

7. The water electrolysis catalyst according to claim 1, wherein, the catalyst is distributed in a grid manner on the catalyst support layer, and a length or width of a grid of the grid-like catalyst is from 1 cm to 100 cm.

8. The water electrolysis catalyst according to claim 1, wherein, the catalyst support layer has a square or circular shaped configuration.

9. The water electrolysis catalyst according to claim 1, wherein, the catalyst is formed orderly on the catalyst support layer.

10. The water electrolysis catalyst according to claim 1, wherein, the catalyst support layer is a porous layer or a diffusion layer.

11. The water electrolysis catalyst according to claim 1, wherein, the catalyst support layer is a diaphragm, a proton exchange membrane, or an anion exchange membrane.

12. The water electrolysis catalyst according to claim 1, wherein, the catalyst is formed at one side of the catalyst support layer.

13. The water electrolysis catalyst according to claim 1, wherein, the catalyst is formed at two opposite sides of the catalyst support layer.

14. The water electrolysis catalyst according to claim 1, wherein the catalyst support layer comprises at least one gas passage channel formed on the catalyst support layer.

15. The water electrolysis catalyst according to claim 1, wherein the catalyst comprises at least components in mass percentage of 70% to 95% of Ni.

16. The water electrolysis catalyst according to claim 1, wherein, the nanowires or nanochains of the catalyst are formed in-situ on the catalyst support layer.

17. A water electrolysis device, comprising:
a membrane layer,
at least two diffusion layers located at opposite sides of the membrane layer, and
at least one catalyst layer, formed between the membrane layer and the diffusion layer and comprising:
nanowire or nanochain microstructures, formed on a catalyst support layer; and
nanoparticles, stacked to form the nanowire or nanochain microstructure, wherein, a diameter of the nanoparticles is from 5 nm to 500 nm.

18. The water electrolysis device according to claim 17, wherein, catalyst components of the catalyst layer used as an anode catalyst and a cathode catalyst are same.

19. The water electrolysis device according to claim 17, wherein, catalyst components of the catalyst layer used as an anode catalyst and a cathode catalyst are different.

20. The water electrolysis device according to claim 17, further comprising at least two electrode sheets, wherein the at least two electrode sheets are respectively located between the membrane layers and the diffusion layers, and each of the electrode sheets comprises the catalyst layer and the catalyst support layer.
